(19) United States
(12) Patent Application Publication
(10) Pub. No.: US 2026/0263989 A1
(43) Pub. Date: Sep. 10, 2026

(54) PROCESS FOR STRIPPING CO2 FROM SOLUTIONS OF ALKALI METAL CARBONATES

(71) Applicant: GIAMMARCO TECHNOLOGIES S.R.L., Venezia (IT)

(72) Inventor: Walter GIACOPINI, Padova (IT)

(73) Assignee: GIAMMARCO TECHNOLOGIES S.R.L., Venezia (IT)

(21) Appl. No.: 19/164,239

(22) PCT Filed: Mar. 6, 2024
(86) PCT No.: PCT/IB2024/052139

§ 371 Date: Sep. 11, 2025

(30) Foreign Application Priority Data
Mar. 14, 2023 (IT) 102023000004794

(51) Int. Cl. B01D 53/14

(52) U.S. Cl. CPC B01D 53/1425; B01D 53/1475; B01D 53/1493; B01D 2251/30; B01D 2251/606; B01D 2252/10; B01D 2252/20494; B01D 2257/504

(57) ABSTRACT

A process for stripping CO₂ from solutions of alkali metal carbonates which have absorbed the same CO₂, includes:
a vacuum regeneration in a first stripping column, in which steam is injected directly into a bottom portion of the column, fed through a first duct with a solution that has absorbed the CO₂ and exits via an outlet duct of the regenerated solution;
a heat transfer by the regenerated solution exiting the column, having a temperature such as to allow a heat exchange between a mixture of hot gases at a partial pressure of CO₂ between 0.05-0.25 bar, and the solution; and
a transport of heat from the first exchanger to the bottom of the column via the regenerated solution which, heated in the exchanger, is sent back to the bottom of the column where the regenerated solution undergoes a spontaneous flash, releasing steam used for the regeneration.

### CROSS-REFERENCE TO RELATED APPLICATIONS

This application is a § 371 National Phase of PCT/IB2024/052139, filed Mar. 6, 2024, which claims priority of Italian patent Application Number 102023000004794, the entire contents of all of which are incorporated by reference herein as if fully set forth.

### INVENTIVE FIELD

The present invention concerns a process for stripping CO₂ from solutions of alkali metal carbonates.

### BACKGROUND

Processes are known consisting of an initial absorption phase in a column, in which the gases to be removed react chemically with an absorption solution, and a final regeneration phase in one or more columns, in which the gases absorbed and chemically bonded to the absorption solution are released by external heat and/or steam supplied directly or indirectly for the purpose of recycling the regenerated solution to the absorption phase.

Of particular importance in industrial applications are the processes for the selective removal of CO₂ and similar impurities from gaseous mixtures that contain them, through the use of aqueous solutions of primary, secondary, tertiary ethanolamines or mixtures thereof, complex ethanolamines including amine family “sterically hindered”, of simple or activated alkali metal carbonates with the addition of glycine or other amino acids, primary, secondary, tertiary ethanolamines or mixtures thereof, complex ethanolamines including the family of” sterically “amines hindered”, inorganic promoters such as arsenic oxides, borates and others.

Examples of these well-known processes are Catacarb, Benfield, Carsol and Giammarco-Vetrocoke and whose variants and/or improvements are known and some of these are described in the patents: Eichmeyer (Catacarb) U.S. Pat. Nos. 3,851,041; 3,896,212; 3,932,582; 4,271,132, Benson (Benfield) U.S. Pat. Nos. 3,563,695; 3,642,430; 3,685,960, Van Hecke (Carsol) U.S. Pat. No. 4,035,166. Giammarco et al U.S. Pat. Nos. 3,659,401; 3,714,327; 3,962,404; 4,073,863.

It is known to those skilled in the art that, in the processes of chemical absorption of gases from gaseous mixtures that contain them, the problem encountered is the need for an external heat source for the regeneration of the absorbent solution since the desorption reaction, for the release of the absorbed gases in order to recycle the solution to the absorption phase is highly endothermic.

Not infrequently, at the same plants for the chemical absorption of gases from gaseous mixtures, considerable quantities of heat are available, which can be both external to the process and recoverable from the gases entering or leaving the plant. However, their use as a heat source for the stripping process is often impossible due to their too low enthalpy level.

In order to reduce the dependence of the regeneration of the absorption solution on the external supply of heat and/or steam, low-energy regeneration schemes have been developed and industrially applied which use two or more regeneration columns operating at different pressures or schemes with internal production of steam for multiflash of the absorbent solution with re-compression of the vapor produced by ejectors.

The aim of the invention is to further reduce, or eliminate, the dependence on external heat necessary for the process, and to carry out the selective removal of gases from gaseous mixtures containing them with a process which optimally exploits the advantages deriving from an operation of regeneration in partial vacuum, applicable to all the processes previously mentioned.

Partial vacuum regeneration in itself is already a known process in the state of the art, including the possibility of using waste heat as a thermal source. See for example S. Warudkar, “Influence of stripper operating parameters on the performance of amine absorption systems for post-combustion carbon capture: Part II. Vacuum Strippers”, International Journal of Greenhouse Gas Control, vol. 16, August 2013, pp 351-360. However, the cited document does not address the heat recovery method using the solvent itself.

### SUMMARY

The aim of the invention is to create a heat recovery process which, for some types of solvents used for absorption, can be carried out with the solvent itself in direct contact with the hot gases to be treated before its compression.

The process can be applied to the following families of solvents: aqueous solutions of simple or activated alkali metal carbonates with the addition of glycine or other amino acids, primary, secondary, tertiary ethanolamines or mixtures thereof, complex ethanolamines including the family of “sterically” amines hindered”, inorganic promoters such as arsenic oxides, borates and others.

These types of carbonate-based solvents, in fact, although presenting different chemical/physical characteristics, share a similar plant configuration in the fundamental features (absorption, thermal regeneration, solution/solution heat exchanger, cooling section of the stripped CO₂). Furthermore, they have no or very weak affinity to react with the gases to be absorbed when the CO₂ in the gases has a very low partial pressure (in the order of approximately 0.05-0.25 bar A). It follows that, if the carbonate-based solvent is put in direct contact with the hot gases to be treated before its compression, it can extract heat from the gas without mass transfer with the exception of any steam which, upon condensing, transforms into water which is added to the solvent itself.

### BRIEF DESCRIPTION OF THE DRAWINGS

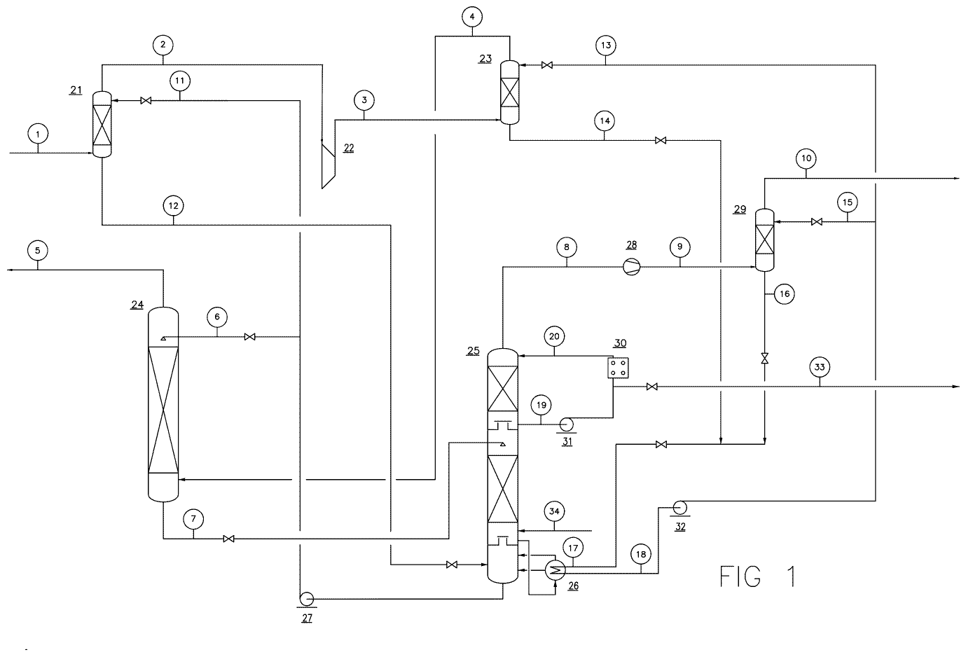

The present invention is further clarified below in one of its practical embodiments, reported for purely illustrative and non-limiting purposes with reference to FIG. 1 showing a plant to carry out the process.

### DETAILED DESCRIPTION OF THE PREFERRED EMBODIMENTS

As can be seen from the FIG. 1 the process according to the invention is implemented by means of a system which includes a pipe 1, for the inlet of a gaseous mixture connected to a heat exchanger 21 in direct contact from which a duct 2 connected to a compressor 22 emerges. equipped with an outlet pipe 3. The pipe 3 is connected to a heat exchanger 23, in direct or indirect contact, from which a pipe 4 emerges connected in turn to a column 24 for chemical absorption of gas from a gaseous mixture. A pipe 5 for the purified gas escape is connected to said column 24.

The column 24 is provided with a pipe 6, for inlet of an aqueous solution, and an outlet pipe 7 connected to a regeneration column 25 which in turn is connected to a pump 27 whose outlet pipe 6 enters the head of the column 24. A duct 11 also departs from the pump 27 which feeds the direct contact exchanger 21. A duct 12 departs from the direct contact exchanger 21 which ends at the bottom of the column 25. In an embodiment variant, not shown in the FIGURE, the displacement of the fluid from the exchanger 21 to column 25 can be obtained through a suitable pump dedicated to the purpose.

At the top of the column 25 there is a condensate inlet duct 20 and an outlet duct 19 which feeds a pump 31 towards a heat exchanger 30.

From the top of the column 25 there also departs a duct 8 which connects to a gas compressor 28 equipped with an outlet pipe 9 which connects to a direct or indirect contact heat exchanger 29 equipped with an outlet pipe 10.

A duct 13 enters from above into the heat exchanger 23 equipped with an outlet pipe 14. A pipe 15 connects to the top of a direct or indirect contact heat exchanger 29 equipped with an outlet pipe 16.

The pipes 14, 16 lead to a pipe 17 which feeds an exchanger 26, equipped with an outlet pipe 18, connected to a pump 32 from which the pipes 13, 15 branch off.

The operation of the system to implement the process is as follows: the gaseous mixture containing the gases to be selectively removed and fed through the pipe 1, after appropriate cooling in the exchanger 21 in direct contact, increases its pressure through the compressor 22. In the exchanger 21, the cooling of the gas is obtained thanks to a stream of aqueous solution of simple or activated alkali metal carbonates with the addition of glycine or other amino acids, primary, secondary, tertiary ethanolamines or mixtures thereof, complex ethanolamines including the family of amines “sterically hindered”, inorganic promoters such as arsenic oxides, borates and others, fed through the pipe 11, and extracted heated through the pipe 12.

If the CO₂ in the gaseous mixture containing the gases to be removed has a very low partial pressure (in the order of approximately 0.05-0.25 bar A), the solutions mentioned above have no or very weak affinity to react with the gases to be absorbed. It follows that, if the carbonate-based solvent, through the pipe 11, is put in direct contact in the exchanger 21 with the hot gases to be treated before its compression, it can extract heat from the gas without mass transfer with the exception of any steam which, by condensing, is transformed into water which is added to the solvent itself: both therefore exit from the exchanger 21 via the duct 12. In particular, the solvent is heated in the path 11-21-12.

After compression, the gas is cooled in the exchanger 23 with direct or indirect contact and then sent, through the duct 4 to the absorption column 24. In the exchanger 23, the cooling of the gas is obtained thanks to a stream of water fed through the pipe 13, and extracted, heated, through pipe 14.

In the column 24 the gas is contacted in countercurrent with an absorbent solution fed to the head of the column 24 from the pipe 6 and in which the selective removal of the gases takes place. In particular, the absorbent solution can be made up of aqueous solutions of simple or activated alkali metal carbonates with the addition of glycine or other amino acids, primary, secondary, tertiary ethanolamines or mixtures thereof, complex ethanolamines including the family of “sterically” amines. hindered”, inorganic promoters such as arsenic oxides, borates and others.

The gaseous mixture deprived of the gases to be removed exits the column 24 through the pipe 5. The solution that has absorbed the gas to be removed from the gaseous mixture in the column 24 exits from the bottom through the pipe 7 and feeds the column 25.

In column 25 the gases chemically absorbed from the solution are released by stripping with steam generated by heat supplied by the exchanger 26, with steam generated by the flash of the incoming solution 12, or with steam fed directly through the pipe 34, and exit from the head of the column 25 along the pipe 8, after cooling by the water flow fed into the column 25, through the pipe 20. The cooling water flow, once heated, exits the column 25 through a pipe 19. It is put back into circulation, after cooling in the heat exchanger 30, by means of the pump 31, while the excess water generated by the cooling of the gaseous stream in the column 25 is disposed of outside the process through the pipe 33.

The regenerated solution after the expulsion of the absorbed gases is extracted from the bottom of the column 25 to feed the circulation pump 27 and re-enters the absorption column 24 through the pipe 6. The pipe 11 also departs from the pump 27, fed by the regenerated solution which it feeds the direct contact exchanger 21. The duct 12 also departs from the direct contact exchanger 21 which contains the solution, heated in the exchanger 21, which is sent to the bottom of the column 25.

The mixture of desorbed gases and steam exiting the head of the column 25 is fed to the compressor 28 which keeps the pressure of the column 25 below atmospheric pressure, allowing the regeneration of the solution under partial vacuum.

After compression, the mixture of desorbed gases and steam is cooled in the heat exchanger 29 with direct or indirect contact and then sent to the outside through the pipeline 10. In the heat exchanger 29 the cooling of the mixture of desorbed gases and steam is achieved thanks to a flow of water fed through the pipe 15, and extracted heated through the pipe 16.

The following liquid flow rates:
i) the cooling water feeding the exchanger 23 through the pipe 13 and exiting heated through the pipe 14, and
ii) the cooling water feeding the exchanger 29 through the pipe 15 and exiting heated through the pipe 16
   taken together or individually, they all constitute a heat source that can be used to power the exchanger 26 through the pipe 17.

The heat exchange in the exchanger 26 is made possible since the reduced pressure in the column 25, obtained through the action of the compressor 28, causes a reduction in the boiling temperature of the absorbent solution, bringing it into the range of 50-95° C. It should be noted that this range of boiling temperatures is impossible to obtain by carrying out a regeneration of absorbent solutions at atmospheric pressure or higher, whether they are aqueous solutions of primary, secondary, tertiary ethanolamines or mixtures thereof, complex ethanolamines including the amine family “sterically hindered”, or of simple or activated alkali metal carbonates with the addition of glycine or other amino acids, primary, secondary, tertiary ethanolamines or mixtures thereof, complex ethanolamines including the family of “sterically” amines hindered”, inorganic promoters such as arsenic oxides, borates and others.

The heating water entering through the pipe 17, and having cooled in the exchanger 26, leaves the exchanger itself through the pipe 18 to feed, through the pump 32, the pipes 13, 15, taken together or individually, which constitute the cooling means for the exchangers 23, 29 respectively.

Thanks to the reduced pressure in column 25, it is also possible to obtain regeneration heat from the flash of solution 12 fed to the bottom of column 25. In fact, in the circuit 27-11-21-12, the solution, regenerated in column 25 and taken from the bottom of the same, is sent to exchange heat with the hot gases (at higher pressure) in the exchanger 21, undergoing a rise in temperature. The solution is then sent back to the bottom of the column 25 and, thanks to the reduced operating pressure, the solution cools, undergoing a spontaneous flash in which it develops steam, the latter used for the regeneration of the solution itself which descends along the column 25, as described previously.

Consider the multiple advantages of the 27-11-21-12 circuit:
direct contact heat exchange is what allows the best possible thermal approach, i.e. temperature difference between the fluid to be heated and the gas mixture to be cooled. This exchange allows maximizing the extraction of heat at a low enthalpy level or, for the same amount of heat exchanged, minimizing the level of partial vacuum in the regenerator 25 and consequently the electrical consumption of the compressor 28;
exploits the very weak affinity between gas mixtures, for example containing CO₂, uncompressed and absorbent solutions based on alkali metal carbonates. In fact, during direct contact between gas and liquid, there is no significant absorption of gas, for example CO₂, but only heating of the solution and cooling of the gas. Therefore the only result is a heat transfer from the gas to the solution, which can be used directly for heat transport;
it does not require dedicated equipment for heat transmission, since the solution, if sent, after heating in the exchanger 21, to the bottom of the regeneration column 25, develops steam by flash, thus obtaining a reduction in system costs.

Thanks to the reduced pressure in the column 25, it is also possible to introduce into the duct 34 a stream of steam generated by boiling water through heat obtained from thermal waste external to the process, at temperatures between 5° and 95° C. This steam current contributes to the regeneration of the absorbent solution within the same column 25.

From what has been said it appears that the process according to the invention has numerous advantages and in particular:
i) the possibility of recovering heat from the gas to be treated, even at temperatures that normally do not allow any energy recovery;
ii) the possibility of recovering the thermal energy produced through the compression of gas, be it the gas to be treated or the gas produced by the treatment;
iii) the possibility of feeding the regeneration column 25 with steam produced at a pressure lower than atmospheric pressure thanks to other thermal waste external to the process, at temperatures between 50° C. and 95° C., or directly with thermal waste external to the process.

From what has been said, it is clear that a drastic reduction or total elimination of the need to supply external heat for the regeneration of the absorption solutions of the gases to be removed is obtained, since the heat to be supplied for the regeneration of the absorbent solution is transmitted by the process itself thanks to the heat exchanges described in the previous points.

### Example 1

A gas flow rate with Dry Flow=22750 Nm3/h, atmospheric P and T=220° C. with CO₂ content in the gas equal to 14.33% dry basis, feeds a selective absorption section c of CO₂.

Vetrocoke (GV) selective absorption section, approximately 5.2 MW thermal and 1.5 MW electrical are required to capture 90% of the CO₂ contained in the gas.

In the process according to the invention, there is an electrical burden mainly due to the electrical needs of the compressor which keeps the stripper at a pressure lower than atmospheric pressure. With equal conditions at the Battery Limits, an electrical demand of 2.4 MW is obtained. However, the thermal demand is completely canceled out by virtue of the total endogenous recovery of the contained heat:
i) in the incoming gas,
ii) generated through the compression of the gas to be treated,
iii) generated through the compression of the treated CO₂.

The overall electrical burden of 2.4-1.5=0.9 MWe is justified if the cost of 0.9 MWe is less than the thermal saving of 5.2 MWt or, when the ratio between electrical and thermal unit cost (MWe/MWt) is less than 5.2/0.9=5.8 times.

1.-5. (canceled)

6. Process for stripping CO₂ from solutions of alkali metal carbonates which have absorbed the same CO₂, the method comprising:
a vacuum regeneration in a first stripping column, in which steam is injected directly into a bottom portion of the first stripping column, said first stripping column being fed through a first duct with a solution that has absorbed the CO₂, said first stripping column also includes an outlet duct of the regenerated solution;
a heat transfer by the regenerated solution exiting the first stripping column, which, due to below atmospheric pressure in said first stripping column, is at a temperature such as to allow a heat exchange between a mixture of hot gases at a partial pressure of CO₂ comprised between 0.05-0.25 bar, and the solution, through direct contact in a first exchanger; and
a transport of heat from the first exchanger to the bottom of the first stripping column owing to said regenerated solution which, heated in the exchanger in direct contact, is sent back to the bottom of the first stripping column through a second duct and in which, being at a temperature higher than its boiling temperature at the pressure of the first stripping column, the regenerated solution undergoes a spontaneous flash which releases steam used for the regeneration of the solution itself.

7. The process according to claim 6, wherein amino acids are added to the solution of alkali metal carbonates.

8. The process according to claim 6, wherein borates are added to the solution of alkali metal carbonates.

9. The process according to claim 6, further comprising a first compression step of the mixture of hot gasses, which heat from compression being extracted by a second heat exchanger in indirect or direct contact, fed with process water, said heat being transferred to the bottom of said column through a third heat exchanger.

10. The process according to claim 9, further comprising a second compression step of the mixture of hot gasses, which heat from compression being extracted by a fourth heat exchanger in indirect or direct contact, fed with process water, said heat being transferred to the bottom of said column through said third heat exchanger.

11. The process according to claim 7, further comprising a first compression step of the mixture of hot gasses, which heat from compression being extracted by a second heat exchanger in indirect or direct contact, fed with process water, said heat being transferred to the bottom of said column through a third heat exchanger.

12. The process according to claim 11, further comprising a second compression step of the mixture of hot gasses, which heat from compression being extracted by a fourth heat exchanger in indirect or direct contact, fed with process water, said heat being transferred to the bottom of said column through said third heat exchanger.

13. The process according to claim 6, further comprising exploiting the heat of sources at temperatures between 5° and 95° C., external to the process, to evaporate water at reduced pressure and generate steam injected through a pipe in the first stripping column and used for the partial thermal regeneration of the solution entering from a top portion of said first stripping column.
